(19) United States
(12) Patent Application Publication
(10) Pub. No.: US 2017/0039496 A1
(43) Pub. Date: Feb. 9, 2017

(54) Bookmarking for Project Management Platform

(71) Applicants: Aavishkar Bharara, Bangalore (IN); Praveen Kumar P, Bangalore (IN); Virendra Shukla, Sonebhadra (IN); Meghana Ts, Hyderabad (IN)

(72) Inventors: Aavishkar Bharara, Bangalore (IN); Praveen Kumar P, Bangalore (IN); Virendra Shukla, Sonebhadra (IN); Meghana Ts, Hyderabad (IN)

(73) Assignee: SAP SE, Walldorf (DE)

(21) Appl. No.: 14/857,349

(22) Filed: Sep. 17, 2015

(30) Foreign Application Priority Data
Aug. 6, 2015 (IN) 4106/CHE/2015

(51) Int. Cl. G06Q 10/06

(52) U.S. Cl. CPC G06Q 10/06312

(57) ABSTRACT

A project management system is provided with bookmarking features. The bookmarks can be created by the user, or generated based on one or more rules. The bookmark information can be stored in a bookmark information repository. Based on the bookmarks, a listing of the bookmarked entries in the project management system can be generated. Related method, apparatus, and non-transitory computer readable medium are also provided.

### CROSS-REFERENCE TO RELATED APPLICATION

This patent application claims the priority of Indian Patent Application No. 4106/CHE/2015, filed on Aug. 6, 2015, the contents of which are incorporated herein by reference in their entireties.

### TECHNICAL FIELD

The subject matter described herein relates to system generated and user specified bookmarking in project management platforms and or applications.

### BACKGROUND

Typically, in project management software, a project can be created with a start date and an end date. The project can include a hierarchy of various activities or tasks that need to be completed to complete the project. Each activity, for example, can comprise of sub-activities, and some activities can require, for example, procuring/producing or outsourcing materials (e.g., buying cement for construction of a building).

In a typical day of a project manager, the person is interested to know which “key activities” to focus on and come up with a “to-do” list of those activities. Performance of the project manager typically depends on how well he/she creates the list, and remembers it. It also depends on, for example, how well the project manager ensures that the activities are timely and well executed, and that the required resources are provided on time. There is, however, no good automation available in current software solutions to make this error-free and well organized.

The project manager would also be interested to know how certain or activities of interest are doing. Currently, however, project managers would need to track these separately, which can lead to human and other errors, especially when the project involves, for example, a complex hierarchical structure.

### SUMMARY

Variations of the current subject matter are directed to methods, systems, devices, and other articles of manufacture that are provided to assist the project manager in managing a project in a project management platform.

The current subject matter provides a method that includes checking, using at least one data processor, each of a plurality of activities stored on a project management system, the plurality of activities being associated with a particular project and include associated activities data. The method also includes identifying, using at least one data process, a set of relevant activities stored on the project management system that meet one or more pre-defined criteria. The relevant activities are bookmarked, using at least one data processor, each bookmark, when created using the project management system causes the at least one data processor to store an unique identifier in a bookmark information repository associated with the particular project. The method also includes generating, using at least one data processor, a list of the bookmarked activities using the project management system.

In some variations, the bookmark information repository includes, for each bookmark, a data field for storing the unique identifier, and additional data relating to the respective bookmark.

In some variations, the associated activities data include a respective due date, and the one or more pre-defined criteria include a pre-defined date. In some variations, the associated activities data include a respective budget, and the one or more pre-defined criteria include whether the respective budget has been exceeded. In some variations, the associated activities data include a respective materials requisition or delivery due date, and the one or more pre-defined criteria include a pre-defined date.

In some variations, the method also includes color coding and/or other means of highlighting, using at least one data processor, the bookmarked activities when displaying the bookmarked activities to a user. The method can also include storing, by at least one data processor, display data including information on how a particular bookmarked activity was displayed to the user so that it can be displayed to the user in the same way when displayed to the user again.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter also provides A project management system including at least one data processor and memory storing instructions which, when executed by the at least one data processor, result in operations that include checking each of a plurality of activities stored on a project management system, the plurality of activities being associated with a particular project and include associated activities data. The operations also include identifying a set of relevant activities stored on the project management system that meet one or more pre-defined criteria, and bookmarking the relevant activities. Each bookmark, when created using the project management system, causes the at least one data processor to store a unique identifier in a bookmark information repository associated with the particular project. The operations also include generating a list of the bookmarked activities using the project management system.

In some variations, the bookmark information repository includes, for each bookmark, a data field for storing the unique identifier, and additional data relating to the respective bookmark.

In some variations, the associated activities data include a respective due date, and the one or more pre-defined criteria include a pre-defined date. In some variations, the associated activities data include a respective budget, and the one or more pre-defined criteria include whether the respective budget has been exceeded. In some variations, the associated activities data include a respective materials requisition or delivery due date, and the one or more predefined criteria include a pre-defined date.

In some variations, the operations further include storing display data including information on how a particular bookmarked activity was displayed to the user so that it can be displayed to the user in the same way when displayed to the user again.

The subject matter described herein provides many advantages. For example, bookmarking can help the project manager to focus on priorities for a given timeframe (e.g., today, this week, etc.) instead of trying to identify them manually or haphazardly. Bookmarks can be shared with other colleagues to facilitate teamwork using the project management platform. By providing the ability to create rules engine for creating user-based rule bound bookmarking, projects with complex hierarchical activities structures can be better managed. A simplified user interface can also be provided to enable the project manager to view, for example, a project dashboard (e.g., without the need for a Gantt chart).

### BRIEF DESCRIPTION OF THE FIGURE

FIGS. 1-6 are screenshots showing various features in accordance with some variations of the current subject matter;

FIG. 7 is a diagrammatic illustration of a project management system in accordance with the current subject matter; and

FIG. 8 is a process flow of an example of the current subject matter.

### DESCRIPTION

Based on the Project Management Institute (PMI), A guide to the Project Management Body of Knowledge (PMBOK guide), a project can be defined as:
A temporary endeavor undertaken to create unique product, service or result. The temporary nature of the project indicates that the project has a definite beginning and end.

While managing a project, the project manager typically has to strike a fine balance between various constraints such as Scope, Quality, Schedule, Budget, Resources, and Risks.

To manage these effectively and efficiently, there are various Project Management tools in the market. Some of these solutions cater to different needs of the industries. For example, SAP Project Systems can be implemented by organizations handling large scale projects such as constructing a factory, SAP Portfolio and Project Management can be implemented by organizations executing IT projects and SAP commercial Project Management can be implemented in the order and bid process and to integrate end-to-end processes of the Engineering to Order (ETO) projects.

To manage the project constrains (e.g., Scope, Quality, Schedule, Budget, Resources, and Risks), the project can be broken down into smaller manageable objects. In the project management terminology, these are sometimes called “Work Breakdown Structures (WBS).” A WBS can be further broken down into manageable WBS elements. Therefore, WBS can result in hierarchical decomposition of total work required to accomplish the project and create the required deliverables.

To come up with the required deliverables, specific actions will have to be performed and these are generally called “Activities.” The Activities are also sometimes referred to as “Tasks,” which sometimes need to be carried out in a particular fashion, for example, in a sequence or in parallel. Sometimes, to carry out a specific activity, resources such as material, labor, etc. can also be required.

Each activity or task can have a duration that helps in determining the overall schedule of the project. The activities that are responsible for determining the overall duration of the project are generally called “critical path activities.” It is critical because any changes to the duration of these activities will change the project timeline(s). In some variations, a project management platform can be configured to provide the ability to highlight, for example, only activities on the critical path.

However, in a typical day of the project manager, the person is interested to know what the “key activities” are to focus on. In some variations, using the bookmarking features provided herein, key activities can be bookmarked, and can be presented in a “to-do” list for the project manager. This can help the project manager create what is referred herein as “What is of prime importance” for the project manager. These need not necessarily be on the critical path. Hence, it allows a mechanism for the project manager to take decisions using data points created by her apart from system generated analytical critical path activities.”

Project managers are typically evaluated by how well he/she remembers the list, and how well he/she ensures that the activities are well executed and that the required resources are provided on time. Accordingly, project managers would also be interested to know how certain items/activities are doing. By providing the bookmarking features of the current subject matter, project managers will have convenient access to the bookmarked activities and can better manage the project.

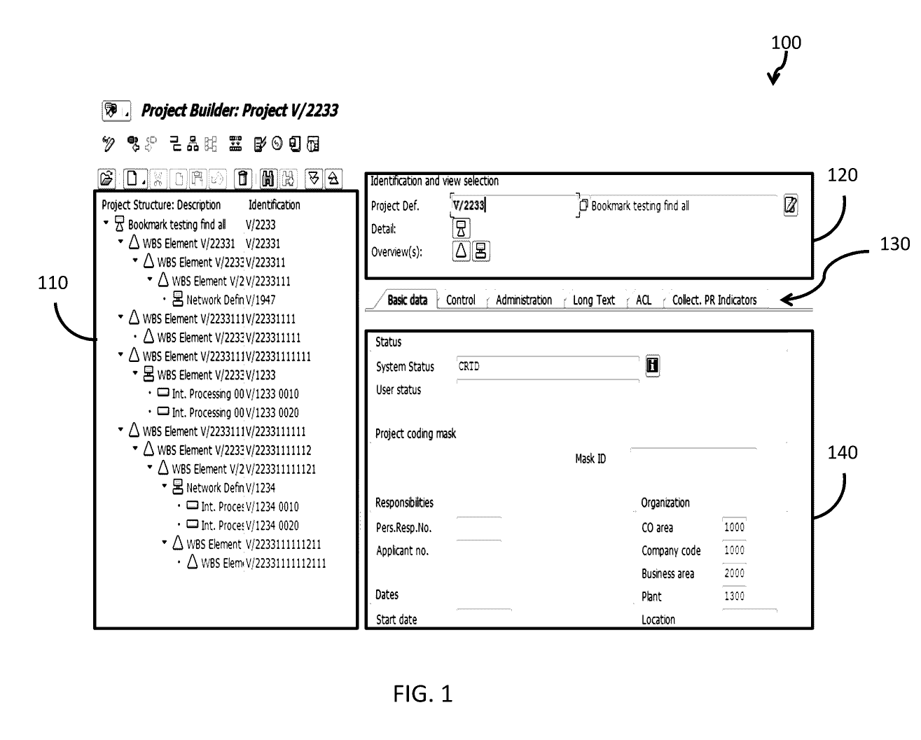

One of more features of the current subject matter can be implemented on a project management system (e.g., an existing project management system). For example, references will now be made to FIGS. 1-6 which illustrate various features of the current subject matter implemented on the SAP Project System.

The following graphic icons (symbols) represent various components (objects) of the project through a graphic user interface (GUI) provided on the system:

[symbol] Represents project definition.

[symbol] Represents WBS element.

[symbol] Represents activity.

These icons are provided for illustrative purposes only; other graphical representations can be used in some variations.

In some variations, activities can be grouped together in a logical object called network. In this example, this is represented by the object [symbol] .

FIG. 1 shows a portion of the graphical user interface through which the user (e.g., project manager) can interact (e.g., provide input and receive visual output) with the project management system. In this example, the user interface screen 100 includes an activities/tasks display area 110 on the left side of the screen, an overview section 120 showing the selected activity/task, a series of tabs 130 for displaying various types of data associated with the selected activity/task, and the data information display area 140 for displaying the associated data for the selected tab.

Here, the project (V/2233) has multiple activities associated with the project. As can be seen, the activities are hierarchical in structure and the hierarchy is represented visually in the user interface. Here, no activity has been “pinned” or “bookmarked” as a “bookmarked activity.”

In some variations, the current subject matter can provide a rules engine, which is configured to allow the user (e.g., project manager) to define one or more bookmarking criteria. Examples of these criteria include activities that are due today, activities that are due this week (or within a specified timeframe), activities that are near a critical path (and not necessarily critical path activities), activities in which cost is due for payment today (or this week, etc.), and activities in which the cost has exceeded a specified budget or activities where the cost has exceeded the “alarm limit” (which is lower than the budged limit to get early intimations).

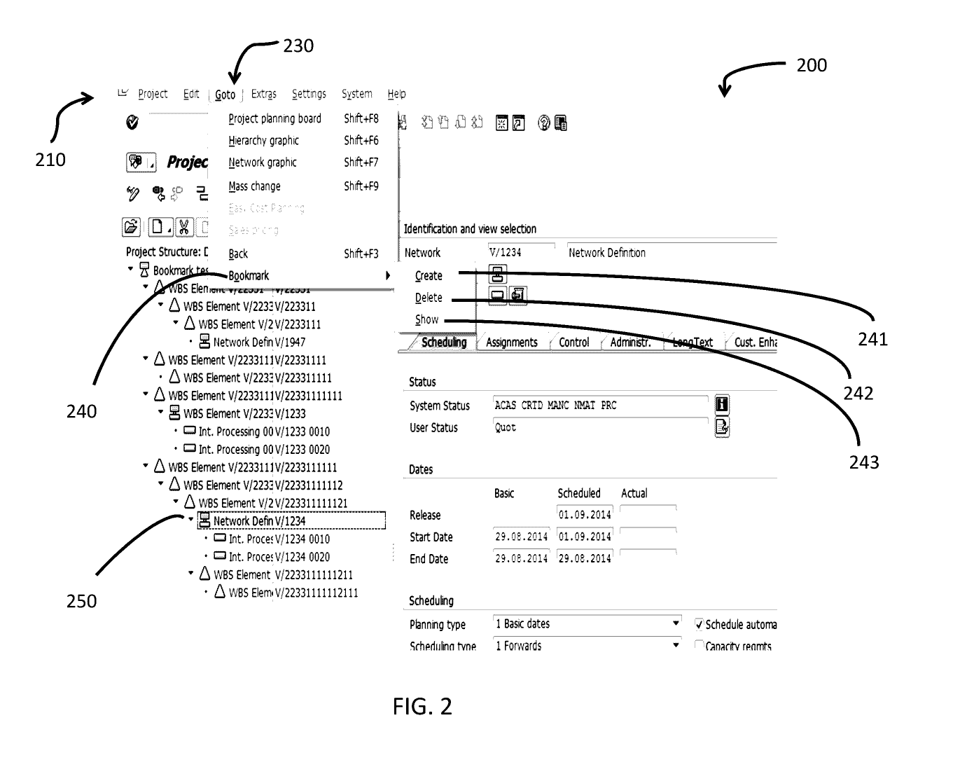

In some variations, the user can navigate the project activities and select one or more activities to be bookmarked. See, for example, FIG. 2, which shows that the user interface is provided with a bookmark option 240 under the “Goto” menu 230 in the menu bar 210. The option 240 includes “Create” (241), “Delete” (242), and “Show” (243), which allows the user respectively to create, delete, and show one or more bookmarked activities. In some variations, the bookmark option can be provided in other menus. In some variations, separate icons representing shortcuts to one or more bookmark actions can also be provided. These menus are depicted for illustrations only and can be achieved with different menu names and or using shortcut keys or any other user interface.

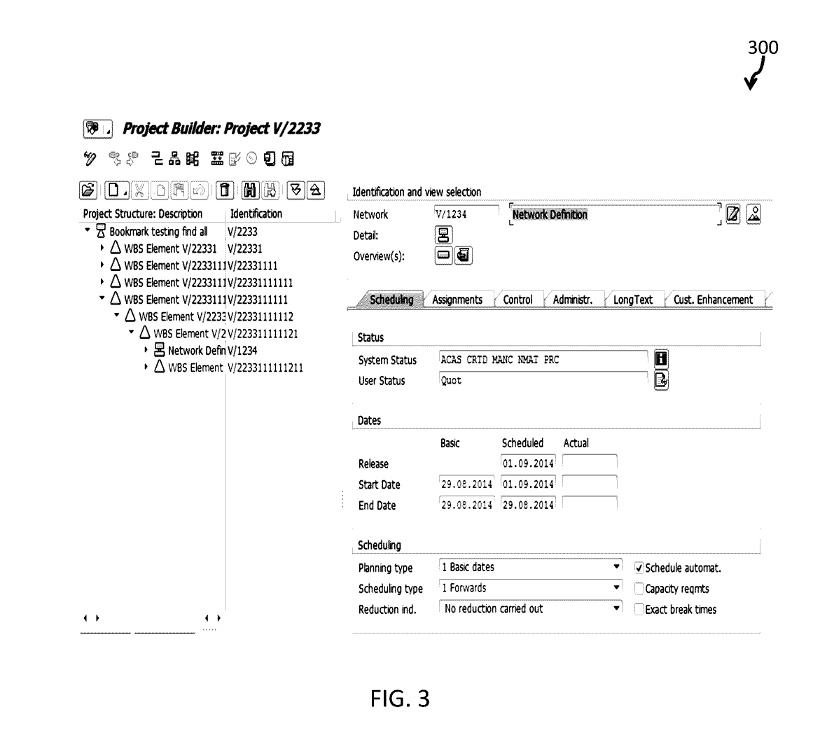

FIG. 3 shows the same project loaded in the Project Management Software. Here, the project is expanded arid the focus is on the last saved bookmark.

In some variations he system is configured to allow the user to select the object (activity) to be the bookmarked and using something referred herein as “Create” feature to create (or mark or select) a bookmark for the selected object. Here, the selected object for bookmarking is the network “Network Definition” (activities that are grouped together) 250 having the ID V/1234. The right side of the screen includes information related to the selected object. These can however be done for any of the Object types in project management like activities, networks, materials, etc.

Similarly, to delete a bookmark, the user can select the bookmarked object to be deleted (or it can also be archived or de-marked) from bookmarking by selecting the “Delete” feature. In some variations, this only deletes the bookmarking of the object, and does not make any other changes to the object.

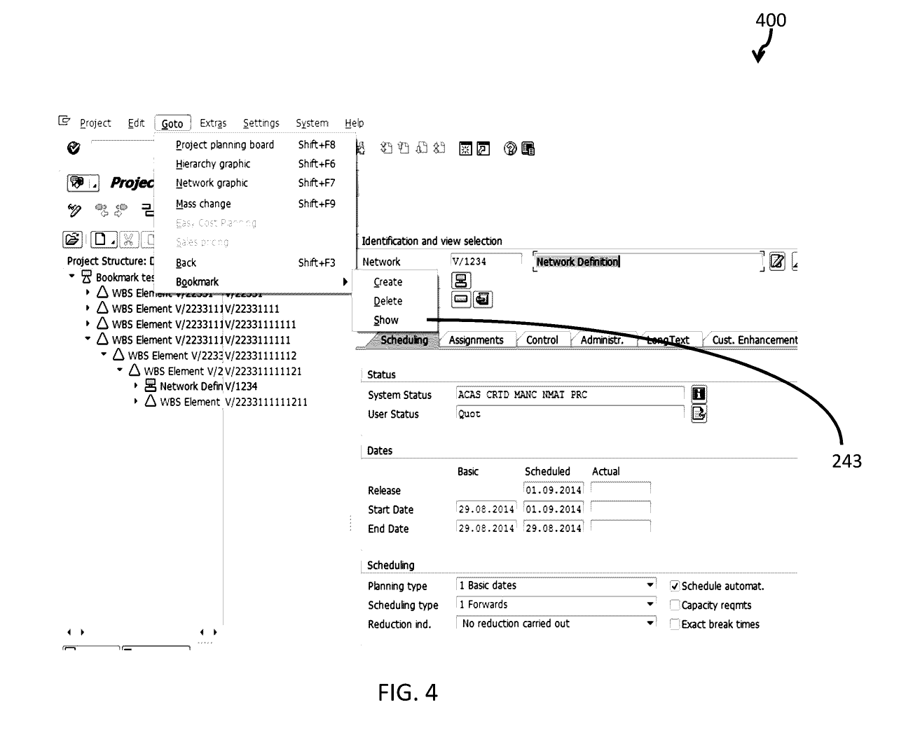

To see the bookmarked objects, the user can select the “Show” feature 243 as shown in FIG. 4. Using this feature, the user interface will display a list of the bookmarked objects (activities, etc.) to allow the user to quickly identify those objects and navigate them.

In some variations, a bookmark information repository is provided to hold and/or store the bookmark information. For example, each bookmark can be uniquely identified by an identifier (e.g., ‘identified’). The bookmark information can include additional fields for storing data representing one or more of: the identity (e.g., user name), system changed, system configured, type of project management entity, configuration identified (e.g., schedule-based, cost based, etc.), data and time of change, etc. These can be stored for each project, or can be created in project independently.

In some variations when a user saves or marks a bookmark, all the relevant information can be stored d retained in the bookmark information repository (for example, provided as part of the Project Database 720, or using similar storage means). In case of rule-bound bookmarking, the bookmark information can also include one or more tables that hold the rule details. One or more data views can be provided to enable the user to maintain (e.g., configure) the rules.

In some variations, features of the current subject matter can be configured in a way that can be readily extended to other platforms. For example, features described herein that are implemented in one SAP application can be readily extended to SAP Portfolio and Project Management, SAP Commercial Project Management and other SAP solutions where the features can be implemented.

In some variations, only the rules are configured (and/or stored) and the bookmarks can be determined “on the fly” without actually being stored physically anywhere.

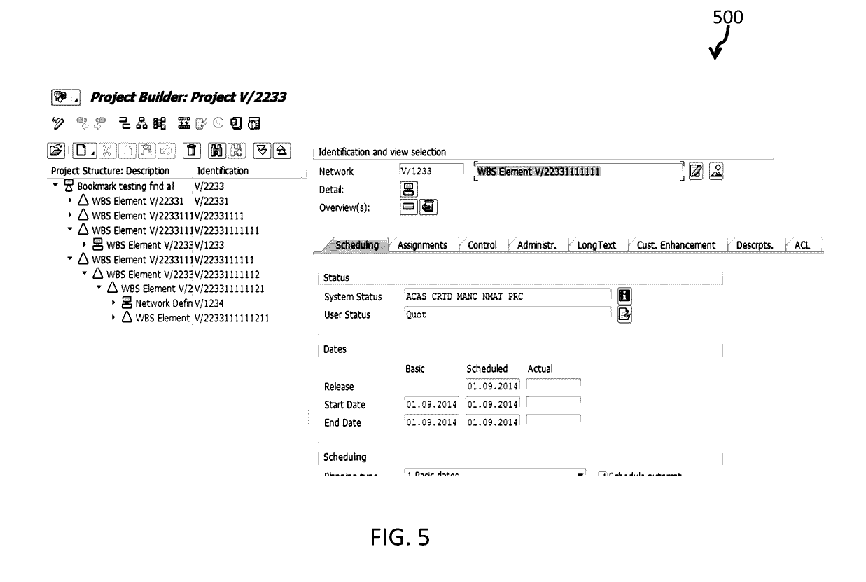

After selecting a particular bookmark from the list, the focus can be set to the new object and the corresponding data can be displayed on the screen (e.g., on the right hand corner of the screen shown in FIG. 5). Here, different tabs (e.g., Scheduling, Assignments, Control, Administr. LongText, Cust. Enhancement, Descrpts., ACL) are provided to show various data related to the selected object. These tabs and various data are provided herein for illustrative purposes, and in some variations, these can be customized (e.g., added, deleted, modified, etc.) as desired by the user.

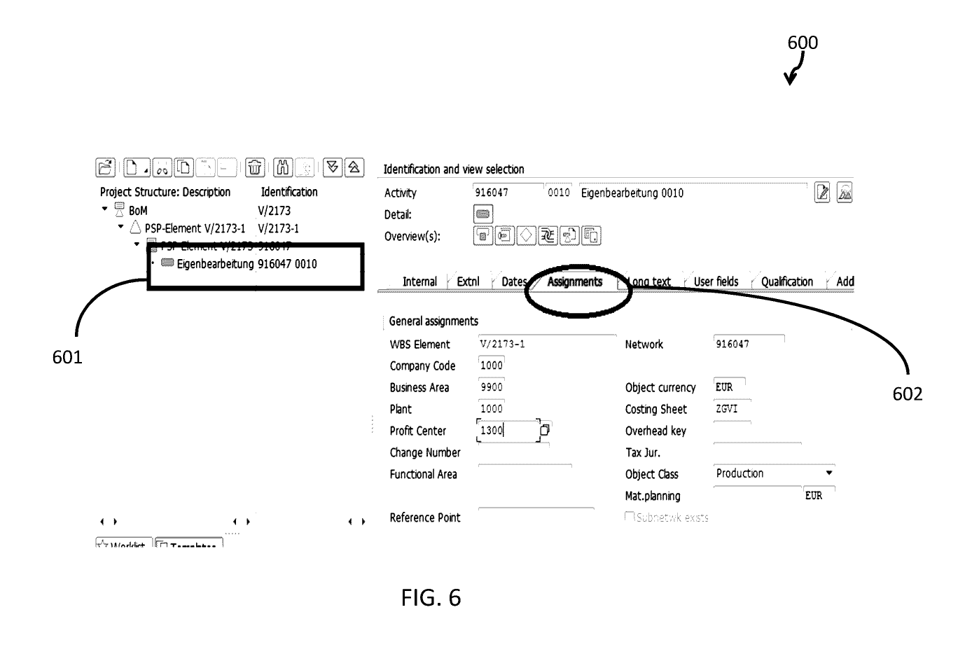

Referring to FIG. 6, each bookmark can be configured to store data such as the last state of the bookmark as viewed. For example, if a bookmark (601) was viewed with a specific tab (e.g., the Assignments tab 602) opened, the next time this bookmark is viewed, it will also have that specific tab opened.

In some variations, one or more bookmarks can be shared with one or more users. For example, in some variations, the sharing functionality can be configured to allow one or more attributes (e.g., including all) of a bookmark (or bookmarks) to be copied from a first user to one or more other users so that the bookmark(s) are made available (accessible) to the other users as well. This can enable collaboration between or among the users.

In some variations, the bookmarking can be configured to be generated automatically using, for example, a set of rules, or artificial intelligence. For example, the project management system can be configured to propose or generate bookmarks based on one or more criteria (or rules).

In some variations, the system can be configured to generate time-based or schedule-based bookmarking. The system can run through the entire project (e.g., repeated for each of the activities/tasks) and identify the activities/tasks that are due within a certain timeframe (e.g., today, this week, by a certain date, etc.). In some variations, the system can be configured to display the activities that are due within the timeframe with a yellow highlighting. In some variations, the delayed activities (e.g., past due) can be highlighted in red. In some variations, the activities that are on the near critical path can be highlighted as blue. Other colors can also be selected such that the activities/tasks of a certain type can be readily distinguished (e.g., visually) from other type(s).

In some variations, the system can be configured to generate cost/budget-based bookmarking. The system can run through the entire project (e.g., repeated for each of the activities/tasks) and identify the activities/tasks that are nearing cost overrun (the specific parameter may be pre-defined or selected by the user). In some variations, the nearing cost overrun activities/tasks can be, for example, highlighted in yellow on the screen (via the user interface). The system can also run through the entire project (e.g., repeated for each of the activities/tasks) and identify the activities/tasks that have exceeded their budget. In some variations, these activities/tasks can be highlighted in red on the screen (via the user interface). Other colors can also be selected such that the activities/tasks of a certain type can be readily distinguished (e.g., visually) from other type(s).

In some variations, the system can be configured to generate material due date based bookmarking The system can run through the entire project (e.g., repeated for each of the activities/tasks) and identify the activities/tasks that have materials due for this week (for example). This can be shown, for example, with a yellow highlighting. The system can also run through the entire project (e.g., repeated for each of the activities/tasks) and identify the activities/tasks that have materials that are past-due or delayed. In some variations, this can be shown with a red highlighting (for example). Other colors can also be selected such that the activities/tasks of a certain type can be readily distinguished (e.g., visually) from other type(s).

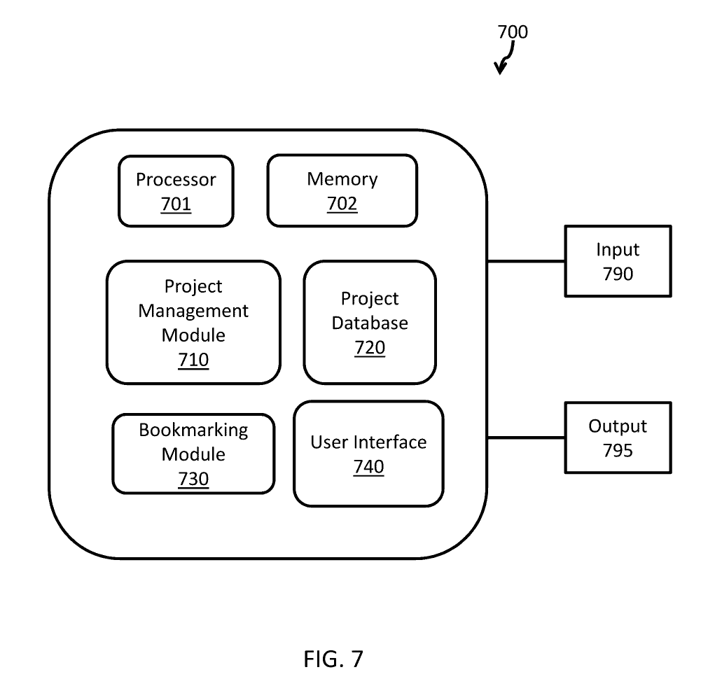

FIG. 7 is a diagrammatic illustration of project management system 700 in accordance with some variations of the current subject matter. In this example, system 700 includes one or more processors 701, memories 702. System 700 also includes one or more input 790 and output 795. Examples of the input 790 include keyboard, mouse, and other input devices; and examples of the output 795 include monitor, printer, and other output devices. The system 700 can communicate with one or more users through the user interface 740 and input 790 and output 795.

System 700 also includes a project management module configured to provide one or more features relating to project management such as some of those shown in FIGS. 1-6, and a project database 720 for storing data related to the project such as, for example, one or more activities/tasks and the associated data. In some variations, the project management modules implements one or more features of the SAP Project Systems.

System 700 further includes a bookmarking module 730 configured to provide one or more bookmarking features such as some of those shown in FIGS. 1-6.

In some variations, system 700 includes a network adapter, and is configured to communicate with other systems and networks. In some variations, the project database 720 can be implemented fully or partly on a remote database with which system 700 is in data communication. In some variations, users can communicate with system 700 and access, for example, the project management module, the bookmarking module, and/or the project database from another device (e.g., a computer, smart device, etc.).

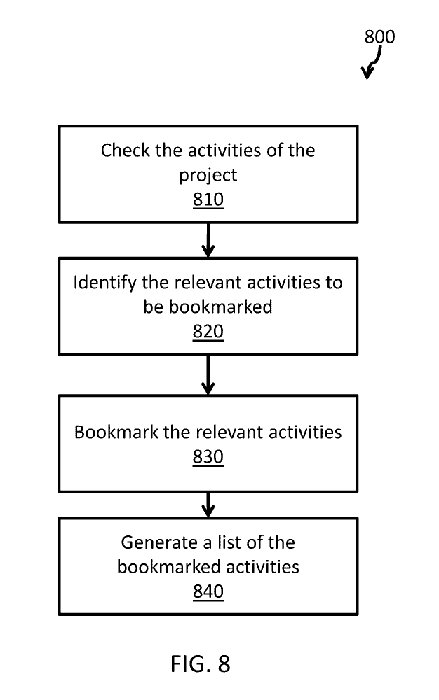

FIG. 8 shows a process flow view of an example of the current subject matter. Here, the system can check each of the activities (e.g., running through the entire project) at 810, and identify at 820 the relevant activities to be bookmarked at 830. At 840, a list of the bookmarked activities can be generated to enable the user to quickly access the bookmarked activities for review. As discussed above, this can be performed based on one or more criteria such as time/schedule based, cost/budget based, and/or materials due date based (and other) criteria to help the user efficiently and accurately bookmark all the relevant activities.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like. Some other interactions may also include, for example, an RFID reader, a bar code scanner to mark the activities as complete.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
checking, using at least one data processor, each of a plurality of activities stored on a project management system, the plurality of activities being associated with a particular project and include associated activities data;
identifying, using at least one data process, a set of relevant activities stored on the project management system that meet one or more pre-defined criteria;
bookmarking, using at least one data processor, the relevant activities, each bookmark, when created using the project management system, causes the at least one data processor to store a unique identifier in a bookmark information repository associated with the particular project; and
generating, using at least one data processor, a list of the bookmarked activities using the project management system.

2. The method according to claim 1, wherein the bookmark information repository includes, for each bookmark, a data field for storing the unique identifier, and additional data relating to the respective bookmark.

3. The method according to claim 1, wherein the associated activities data include a respective due date, and the one or more pre-defined criteria include a pre-defined date.

4. The method according to claim 1, wherein the associated activities data include a respective budget, and the one or more pre-defined criteria include whether the respective budget has been exceeded.

5. The method according to claim 1, wherein the associated activities data include a respective materials requisition or delivery due date, and the one or more pre-defined criteria include a pre-defined date.

6. The method according to claim 1, further comprising color coding and/or other means of highlighting, using at least one data processor, the bookmarked activities when displaying the bookmarked activities to a user.

7. The method according to claim 1, further comprising storing, by at least one data processor, display data including information on how a particular bookmarked activity was displayed to the user so that it can be displayed to the user in the same way when displayed to the user again.

8. A non-transitory computer readable medium storing instructions, which when executed by at least one data processor of at least one computing system, result in operations comprising:
checking, using at least one data processor, each of a plurality of activities stored on the project management system, the plurality of activities being associated with a particular project and include associated activities data;
identifying, using at least one data process, a set of relevant activities that meet one or more pre-defined criteria;
bookmarking, using at least one data processor, the relevant activities, each bookmark, when created using the project management system, causes the at least one data processor to store a unique identifier in a bookmark information repository associated with the particular project; and
generating, using at least one data processor, a list of the bookmarked activities.

9. The non-transitory computer readable medium according to claim 8, wherein the bookmark information repository includes, for each bookmark, a data field for storing the unique identifier, and additional data relating to the respective bookmark.

10. The non-transitory computer readable medium according to claim 8, wherein the associated activities data include a respective due date, and the one or more pre-defined criteria include a pre-defined date.

11. The non-transitory computer readable medium according to claim 8, wherein the associated activities data include a respective budget, and the one or more pre-defined criteria include whether the respective budget has been exceeded.

12. The non-transitory computer readable medium according to claim 8, wherein the associated activities data include a respective materials due date, and the one or more pre-defined criteria include a pre-defined date.

13. The non-transitory computer readable medium according to claim 8, further comprising color coding, using at least one data processor, the bookmarked activities when displaying the bookmarked activities to a user.

14. The non-transitory computer readable medium according to claim 8, further comprising storing, by at least one data processor, display data including information on how a particular bookmarked activity was displayed to the user so that it can be displayed to the user in the same way when displayed to the user again.

15. A project management system comprising:
at least one data processor; and
memory storing instructions which, when executed by the at least one data processor, result in operations comprising:
checking each of a plurality of activities stored on a project management system, the plurality of activities being associated with a particular project and include associated activities data;
identifying a set of relevant activities stored on the project management system that meet one or more pre-defined criteria;
bookmarking the relevant activities, each bookmark, when created using the project management system, causes the at least one data processor to store a unique identifier in a bookmark information repository associated with the particular project; and
generating a list of the bookmarked activities using the project management system.

16. The system according to claim 15, wherein the bookmark information repository includes, for each bookmark, a data field for storing the unique identifier, and additional data relating to the respective bookmark.

17. The system according to claim 15, wherein the associated activities data include a respective due date, and the one or more pre-defined criteria include a pre-defined date.

18. The system according to claim 15, wherein the associated activities data include a respective budget, and the one or more pre-defined criteria include whether the respective budget has been exceeded.

19. The system according to claim 15, wherein the associated activities data include a respective materials requisition or delivery due date, and the one or more pre-defined criteria include a pre-defined date.

20. The system according to claim 15, wherein operations further comprise storing display data including information on how a particular bookmarked activity was displayed to the user so that it can be displayed to the user in the same way when displayed to the user again.
